(19) United States
(12) Patent Application Publication
(10) Pub. No.: US 2003/0014744 A1
(43) Pub. Date: Jan. 16, 2003

(54) Method of checking at least one software application installed on a data processing sytstem

(76) Inventors: Stefan Doll, Essen (DE); Robert Jaeger, Amsberg (DE)

Correspondence Address: Bell, Boyd & Lloyd LLC, P.O. Box 1135, Chicago, IL, 60690, US

(21) Appl. No.: 10/093,645

(22) Filed: Mar. 7, 2002

(30) Foreign Application Priority Data
Jul. 3, 2001 (DE) 101 10 949.0

(51) Int. Cl. G06F 9/44

(52) U.S. Cl. 717/170

(57) ABSTRACT

For the automated version analysis of a software application, the version information of the respective software components is among the information entered in a reference list already during the installation of the software application on a data processing system by a setup program. This reference list is stored in the form of a file in a memory or in a configuration database of the data processing system. During a subsequent proper updating of the software application, the reference list associated with the software application is automatically updated. After creating a reference list, the method of automatic version analysis with respect to the software application installed on the data processing system compares the version information of the software components actually present on the data processing system with the respective version information in the reference list. The comparison information obtained by the comparison (differences or matches) is written into a comparison list.

### BACKGROUND OF THE INVENTION

The present invention relates to a method of checking at least one software application installed on a data processing system and, in association with this, a computer program product and a computer-readable data medium.

A software application generally includes a number of software components. Each software component may in turn, include one or more files, which may be of different types and may be stored in different memory areas of a data processing system. These components usually have their own version information which, in turn, may include different parts; for example, a date of compilation for the first time, version information of the kind “2.0” (or “1.1.2” and so on), etc.

U.S. Pat. No. 5,577,232 already discloses a method and an apparatus for controlling the interaction of computer hardware and an assigned software application when there are different versions of software and hardware. In this case, only those circuits and functions for which the respective version of the software is provided in them are activated in the hardware; that is, enabled. Conversely, only the parts for which the corresponding circuits and functions are present in the hardware version in question are enabled in the installed software. For this purpose, information on the required software version is stored in the hardware. A comparison device reads out the version information of the hardware from a non-volatile memory and compares this with the version information of the software application. If the hardware version is “older” than the software version, and consequently has a smaller functional scope, the software application only addresses those hardware functions and circuits which are found in the “older” hardware version. The functions not yet embodied in the “older” hardware are emulated by the software. For this purpose, the software has a history of the various hardware versions. Conversely, the hardware includes a circuit section for switching off the circuits which are not yet taken into consideration by the software components of an “older” software version that is being used.

Furthermore, U.S. Pat. No. 6,009,401 discloses a mechanism for the distribution of software applications in a network; for example, the Internet. When a software license is acquired by a customer, the version information of the acquired software application is stored at a central location (“License Clearing House”). After that, the customer can for the first time download from a server in the network (“publisher site”) the software application licensed in this way. When there is a renewed request for transmission, for example if the customer would like to use the software application on new hardware, a control location (“Relicensing Manager”) compares the version information of the re-requested software application with the licensed version information and only allows the transmitting operation to proceed if the version of the re-requested software application is older or the same as the licensed version.

Furthermore, JP 10-027095 A discloses a method of automatically downloading the latest version in each case of a software application. For this purpose, with each start, a software application installed on a PC requests from a server the version information of the latest version of the software application kept there. This version information is compared by a comparison device installed on the PC (“Discriminating Part”) with its own version information. If the version of the software application stored on the server is more recent than the version just started, it is transmitted from the server to the PC, where the existing, older version is overwritten.

In the known methods, it has proven to be disadvantageous that the operation of software applications which include a number of software components may be disrupted, this frequently happening after the installation of further software components.

For instance, errors may occur in the implementation of a software application if certain software components or files assigned to the software application and accessed by the software application have not been properly installed by an installation or setup program or an update program on the data processing system. Therefore, for error analysis and elimination, usually the version information of the software components or files associated with the software application affected by the errors is checked. For this purpose, it must be ascertained which version of the individual software component or file is installed on the data processing system. In this way, it can be ascertained, for example, whether the software components or files belonging to a software application all correspond to one specific version.

According to the prior art, for this purpose each software component or file must be separately sought, called up and checked. Such an interrogation can be carried out, for example, via the component property or via what is known as “Info About.” This is obviously laborious and very time-consuming.

An object of the present invention, therefore, is to ensure reliable operation even of software applications having a number of software components.

### SUMMARY OF THE INVENTION

Accordingly, the present provides that a reference list which includes the version information of installed software components is created in the course of installation and that, for checking purposes, the current version information of the installed software components is ascertained. The ascertained version information is compared with the version information stored in the reference list and the differences and/or matches between the current version information and the version information recorded in the reference list are made available as the result. In this way, it is possible to detect inconsistent installations, in which mixing up of software components of different application versions can at least partially occur. On the basis of the reference list, during a new installation or during the re-installation of a new software version, only those software components which are not yet present in the correct version are installed. Checking the version of software components or files assigned to a software application, and consequently troubleshooting of software applications affected by errors, is simplified and the effort involved in the installation of new software versions, such as “updates,” is minimized.

The writing of the reference list may be carried out, in particular, in the course of the installation of the software application on the data processing system.

In what is known as a head region (often referred to in the literature as the “header”) of the reference list, general information, in particular the version information of the software application, and further information on the respective software components or files are stored.

In a subsequent proper updating of the software application, such as by an update program created by the manufacturer of the software application, software components or files are amended, added, deleted or exchanged. According to an embodiment of the present invention, allowance is made for updating by a corresponding automatic updating of the reference list belonging to the software application.

Also proposed according to the present invention is a method of automatic version analysis with respect to the software application installed on the data processing system, in which, after creating the reference list (according to the method described above) the version information of the software components or files actually installed on the data processing system (which, for example, in the case of improper installation of new components do not match those in the reference list) is compared with the software information in the reference list. The comparison information obtained by the comparison, differences or matches, is written into a comparison list.

According to another embodiment of the present invention, the matches ascertained in the course of the comparison are written into a first part of the comparison list and the deviations ascertained in the course of the comparison are written into a second part of the comparison list.

Both the reference list and the comparison list can be stored on a computer-readable data medium.

Also proposed according to the present invention are computer program products which perform the methods described above in cases in which they are loaded into a memory of a data processing system.

Additional features and advantages of the present invention are described in, and will be apparent from, the following Detailed Description of the Invention and the Figures.

### BRIEF DESCRIPTION OF THE FIGURES

FIG. 1 shows a reference list according to the invention directly after installation of a software application.

FIG. 2 shows the reference list after a proper updating (update) of the software application.

FIG. 3 shows a schematic representation of a data processing system, in the memory of which an application, a reference list and software components of different versions are stored

FIG. 4 shows a comparison list created by a version interrogation program.

FIG. 5 shows a flow diagram to illustrate the main method steps taking place in a version analysis according to the present invention.

### DETAILED DESCRIPTION OF THE INVENTION

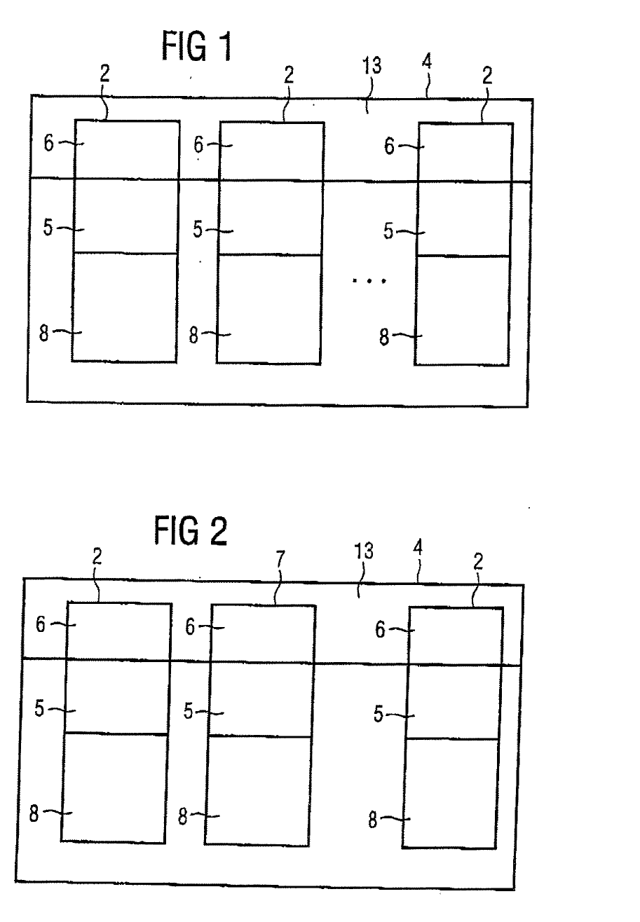

Represented in FIG. 1 is a reference list 4 which according to the present invention, is created directly after installation of a software application on a data processing system (not shown); for example, a “personal computer” or a “workstation.” During the installation of the software application, version information of all the software components or files belonging to the software application and, if appropriate, version information of the software application itself, are written into this reference list 4.

This may, for example, look as follows:

| | |
|---|---|
| product: | HiPath |
| component: | Waccount |
| files: | xyz.exe, xyz.dll |

In the reference list 4, version information 6 and, optionally, a memory location 5 and an identification 8 of the respective software components or files 2 are stored. The reference list 4 has a head region 13, in which specifically the version information 6 of the software application itself is stored.

FIG. 2 shows a state of the reference list 4 as it became after a subsequent properly performed updating of the software application, often referred to in the literature as an “update.” During this, at least some of the software components or files were updated. This updating was entered into the reference list 4 by the version information of the software components or files 7 concerned being updated.

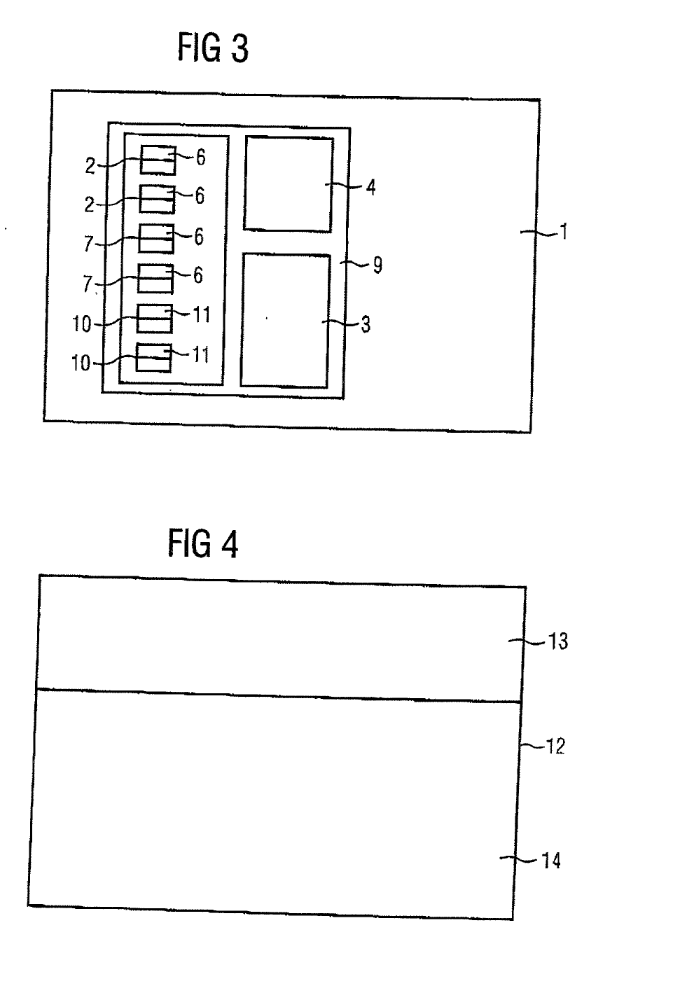

Represented in FIG. 3 is the situation after an improper updating of the software application 3. A software application is improperly updated, for example, if individual software components or files have been exchanged. By contrast with proper updating with an update program, no corresponding updating of the reference list 4 takes place in this case. For this reason, in a memory 9 of the data processing system 1 there are, along with the originally installed software components or files 2 and the properly updated software components or files 7, software components or files 10 of which the version information 11 does not match the reference list 4.

It is intended to describe below how a reference list 4 created according to the method described above can be used during the analysis and elimination of errors in the implementation of a software application 3 on a data processing system 1.

For error analysis, an automatic version analysis is performed, the result of which is a comparison list 12 according to FIG. 4. During the automatic version analysis, the version information of all the software components or files 2, 7, 10 belonging to the software application 3 and actually present on the data processing system 1 is compared with version information in the reference list 4. On the basis of this comparison, the comparison list 12 is created and, if appropriate, displayed to the user.

The comparison list 12 is constructed as follows: in a head part 13 of the comparison list 12 there appears information concerning those software components or files 2 and 7 which are actually present on the data processing system 1 and the version information of which matches the reference list 4.

The version information 11 with respect to the software components or files 10 which are actually present on the data processing system but the version information of which does not correspond to the reference list 4 is entered and/or displayed in what is known as a difference list 14, which is part of the comparison list 12.

Amendments of software components or files which were carried out by simple copying or exchanging consequently can be registered via the difference list 14.

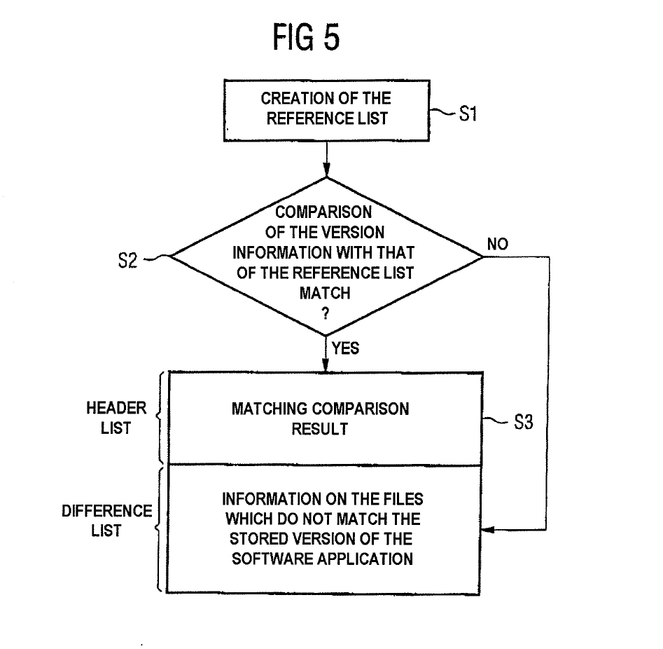

The method according to the present invention is now to be illustrated on the basis of a flow diagram with reference to FIG. 5:

In a first step S-1, information on all the software components or files belonging to a software application, such as, for example, the memory location, the identification, and the version information, are entered in a reference list. This reference list may both take the form of a file (and consequently constitute part of the software application itself) and be stored at a suitable location in a memory or in a configuration database of the data processing system.

In a second step S-2, the comparison of the version information of the software components or files actually present on the data processing system with the version information in the reference list takes place. To be able to locate more quickly the software components or files actually present on the data processing system, the memory location information in the reference list can be accessed. This, of course, only applies if the corresponding software components or files were properly installed or updated, since it is generally only then that the actual memory location matches the memory location of the software component or file concerned that is specified in the reference list.

In a third method step S-3, the comparison list is created on the basis of the comparison of step S-2. For this purpose, information with respect to the actual software components or files, of which the version information matches the information in the reference list, is entered in the head region of the comparison list and information with respect to those software components or files which are actually present on the data processing system but of which the version information does not match the corresponding information in the reference list, and in particular does not match the version information with respect to the software application in the reference list, is entered in the difference list of the comparison list. The comparison list is made available to the user in the form of a text file. It goes without saying that a printout or transmission of the comparison list by e-mail is also possible; for example, to an administrator not based at the site of the data processing system.

Finally, a user wishing to perform an error analysis or error elimination in the case of a software application on the data processing system can see from the comparison list which components or files of the software application match or do not match the software application with regard to their version. The non-matching software components or files may have a high error potential, with the result that an error occurring can be eliminated just by exchanging the non-matching software components or files. Exchanging also can be performed in an automated manner by an installation or maintenance program, which for this purpose reads out from the comparison list stored as a file the names, memory locations and version information of the software components to be newly installed.

It is consequently possible in a simple way and in an automated manner to ascertain the versions of all the software components or files belonging to a software application and display them to the user. Furthermore, an automatic evaluation of this information by a computer program, and consequently an automated “repair” of an installation affected by errors of the software application, is also possible.

Although the present invention has been described with reference to specific embodiments, those of skill in the art will recognize that changes may be made thereto without departing from the spirit and scope of the present invention as set forth in the hereafter appended claims.

1. A method of checking at least one software application, which is installed on a data processing system and which has at least one software component, with at least one item of version information being stored during the installation of the software application, the method comprising the steps of:
creating a reference list, which includes the version information of installed software components, during the installation of the software application;
ascertaining the current version information of the installed software components;
comparing the ascertained version information with the version information stored in the reference list; and
making available, as a result of the comparison, differences and matches between the current version information and the version information recorded in the reference list.

2. A method of checking at least one software application with at least one item of version information as claimed in claim 1, the method further comprising the step of storing the reference list, during the installation of the software application, on the data processing system.

3. A method of checking at least one software application with at least one item of version information as claimed in claim 1, the method further comprising the step of entering, in the reference list, respective memory locations of the registered software components on the data processing system.

4. A method of checking at least one software application with at least one item of version information as claimed in claim 1, the method further comprising the step of automatically updating, during a subsequent proper updating of the software components, the reference list with respect to the updated software components.

5. A method of checking at least one software application with at least one item of version information as claimed in claim 1, the method further comprising the step of writing the result of the comparison as comparison information into a comparison list.

6. A method of checking at least one software application with at least one item of version information as claimed in claim 5, wherein the matches are written into a first part of the comparison list and the differences are written into a second part of the comparison list.

7. A method of checking at least one software application with at least one item of version information as claimed in claim 1, the method further comprising the step of using the result for at least one of updating the software components and re-establishing proper installation of the software application.

8. A method of checking at least one software application with at least one item of version information as claimed in claim 1, wherein the method is implemented via a computer program product upon the product being loaded into a memory of a data processing system.

9. A method of checking at least one software application with at least one item of version information as claimed in claim 5, wherein the comparison list is incorporated in to a computer-readable data medium.
